(19) United States
(12) Patent Application Publication
(10) Pub. No.: US 2026/0342460 A1
(43) Pub. Date: Oct. 29, 2026

(54) System and Method for Real-Time In-Band Cellular Uplink Interference Detection

(71) Applicant: Northeastern University, Boston, MA (US)

(72) Inventors: Tommaso MELODIA, Newton, MA (US); Michele POLESE, Cambridge, MA (US); Neagin Neasamoni SANTHI, Boston, MA (US); Davide VILLA, Brookline, MA (US)

(21) Appl. No.: 19/657,904

(22) Filed: Apr. 24, 2026

Related U.S. Application Data
(60) Provisional application No. 63/794,319, filed on Apr. 24, 2025.

(51) Int. Cl. H04B 17/345; H04W 72/21

(52) U.S. Cl. CPC H04B 17/345; H04W 72/21

(57) ABSTRACT

Systems, apparatus, computer-implemented methods, non-transitory, computer readable medium, and/or computer program products that facilitate in-band or inter-cell uplink interference detection in a radio access network (RAN). In one implementation, a method for in-band or inter-cell uplink interference detection in a RAN includes ingesting, at processing circuitry operating within a physical (PHY) layer of a protocol stack of the RAN, raw in-phase and quadrature (I/Q) data from an uplink transmission slot. The method also includes ingesting, at the processing circuitry, synchronous/contemporaneous observation data generated for the uplink transmission slot. The method further includes generating, by an interference detection model executing on a parallel processing unit (PPU) of the processing circuitry, an in-band interference indication for the uplink transmission slot using the raw I/Q data and the synchronous observation data.

### CROSS-REFERENCE TO RELATED APPLICATIONS

The present application claims priority to U.S. Provisional Patent Application No. 63/794,319, filed on Apr. 24, 2025, the content of which is incorporated herein by reference in its entirety for all purposes.

### STATEMENT REGARDING FEDERALLY SPONSORED RESEARCH OR DEVELOPMENT

This invention was made with government support under Grant Number CNS-2112471 awarded by the National Science Foundation, and under Grant Number W911NF-24-2-0065 awarded by the U.S. Army Research Laboratory. The Government has certain rights in the invention.

### BACKGROUND

The evolution of wireless communication networks or systems has been driven by the increasing demand for high-speed, low-latency, and ultra-reliable connectivity to support emerging applications such as autonomous systems, industrial automation, and immersive experiences. Some wireless communication networks such as fifth generation (5G) or Beyond-5G (B5G) cellular radio access networks (RANs) support such demand by increasing densification to improve throughput and latency within a limited spectrum allocated to mobile communications. For example, in wireless communications networks characterized as ultra-dense networks, network operators can configure multiple neighboring small cells to use overlapping frequency bands or reuse the same frequency bands to increase frequency reuse. Another example, directional millimeter wave systems further push this concept, with commercial deployments often leveraging the same 400 megahertz (MHz) or 800 MHz bands at 28 gigahertz (GHz) and 39 GHz for all base stations. Some private network deployments (e.g., for enterprise scenarios) use limited portions of shared spectrum, with all deployments constrained in the same 100 MHz (e.g., Germany, Brazil, Netherlands) or 150 MHz (e.g., U.S., with Citizens Broadband Radio Service (CBRS). Network performance enhancements such as improved latency obtained via densification, sharing, and spectrum reuse can be offset by increasing in-band or inter-cell interference that degrades network performance.

### SUMMARY

In one implementation, a method for in-band uplink interference detection in a radio access network (RAN) includes, ingesting, at processing circuitry operating within a physical (PHY) layer of a protocol stack of the RAN, raw in-phase and quadrature (I/Q) data from an uplink transmission slot. The method also includes ingesting, at the processing circuitry, synchronous/contemporaneous observation data generated for the uplink transmission slot. The method further includes generating, by an interference detection model executing on a parallel processing unit (PPU) of the processing circuitry, an in-band interference indication for the uplink transmission slot using the raw I/Q data and the synchronous observation data.

In another implementation, an apparatus for in-band uplink interference detection in a RAN includes processing circuitry operating within a PHY layer of a protocol stack of the RAN and memory communicatively coupled to the processing circuitry. The memory storing program instructions executable by the processing circuitry to cause the apparatus to perform operations. The operations include receiving, by an interference detection model executing on a PPU of the processing circuitry, pre-equalization I/Q data from an uplink transmission slot. The operations also include receiving, by the interference detection model, synchronous observation data generated for the uplink transmission slot. The operations further include generating, by the interference detection model, an in-band interference indication for the uplink transmission slot using the pre-equalization I/Q data and the synchronous observation data.

In yet another implementation, non-transitory computer-readable medium has program code stored thereon. The program code, when executed by processing circuitry, cause the processing circuitry to perform operations. The operations include causing an interference detection model executing on a PPU of the processing circuitry to generate an in-band interference indication for an uplink transmission slot using raw baseband data from the uplink transmission slot and synchronous observation data generated for the uplink transmission slot. The operations also include causing a network function of a RAN operating within a medium access control (MAC) layer of the protocol stack to allocate uplink resources of the RAN differently using the in-band interference indication.

### BRIEF DESCRIPTION OF THE DRAWINGS

Aspects of the present disclosure are described in detail below with reference to the attached drawing figures.

FIG. 1 is a block diagram illustrating details of an example wireless communication network or system.

FIG. 2 is a block diagram illustrating an example radio access network (RAN) with an in-band or inter-cell uplink interference detection operating within a physical (PHY) layer of a protocol stack of the RAN, in accordance with aspects of the present disclosure.

FIG. 3 is a diagram illustrating an example of in-band or inter-cell uplink interference detection executing in-line with processing of the PHY layer, in accordance with aspects of the present disclosure.

FIG. 4 is a diagram illustrating an example workflow for integrating in-band or inter-cell uplink interference detection within a graphics processing unit (GPU)-accelerated framework for PHY layer processing, in accordance with aspects of the present disclosure.

FIG. 5 is a diagram illustrating an example neural network architecture for in-band or inter-cell uplink interference detection, in accordance with aspects of the present disclosure.

FIG. 6 is a block diagram illustrating an example RAN operating in different radio frequency (RF) environments with different channel conditions, in accordance with aspects of the present disclosure.

FIG. 7 is a diagram that illustrates various example uplink (UL) transmission scheduling parameters at a base station of the RAN of FIG. 6.

FIG. 8 is a table of example labeling rules that facilitate training models for detection of in-band or inter-cell uplink interference, in accordance with aspects of the present disclosure.

FIG. 9 is an example confusion matrix that illustrates the impact of the number of interference sources on in-band or inter-cell uplink interference detection performance, in accordance with aspects of the present disclosure.

FIG. 10 is a diagram of example performance metrics for interference detection models with different neural network architectures operating in diverse RF environments, in accordance with aspects of the present disclosure.

FIG. 11 is a diagram of example confusion matrices that illustrate the impact of transfer learning on in-band or inter-cell uplink interference detection, in accordance with aspects of the present disclosure.

FIG. 12 is a diagram of example performance metrics that illustrate in-band or inter-cell uplink interference detection latency, in accordance with aspects of the present disclosure.

FIG. 13 is a diagram of example GPU utilization and power consumption metrics associated with in-band or inter-cell uplink interference detection, in accordance with aspects of the present disclosure.

FIG. 14 is a block diagram of a data processing system suitable for implementing in-band or inter-cell uplink interference in wireless communication systems, in accordance with an embodiment of the present disclosure.

### DESCRIPTION

Various implementations disclosed herein relate to techniques that facilitate detection of in-band or inter-cell uplink interference in wireless communication systems such as a radio access network (RAN). As described above, wireless communication networks such as fifth generation (5G) or Beyond-5G (B5G) cellular radio access networks (RANs) support such demand by increasing densification to improve throughput and latency within a limited spectrum allocated to mobile communications. ultra-dense 5G or B5G cellular RANs that leverage spectrum sharing and frequency reuse to enhance throughput can face unpredictable in-band or inter-cell uplink interference challenges that significantly degrade Signal to Interference plus Noise Ratio (SINR) at affected base stations or Next Generation Node Bases (gNBs). This is particularly problematic at cell edges, where overlapping regions force client or user devices (UEs) to increase transmit power, and in directional millimeter wave systems, where beamforming sidelobes can create unexpected interference. The resulting signal degradation disrupts protocol operations, including scheduling and resource allocation, by distorting quality indicators like Reference Signal Received Power (RSRP) and Received Signal Strength Indicator (RSSI), and can compromise critical functions such as channel state reporting and Hybrid Automatic Repeat Request (HARQ) acknowledgments.

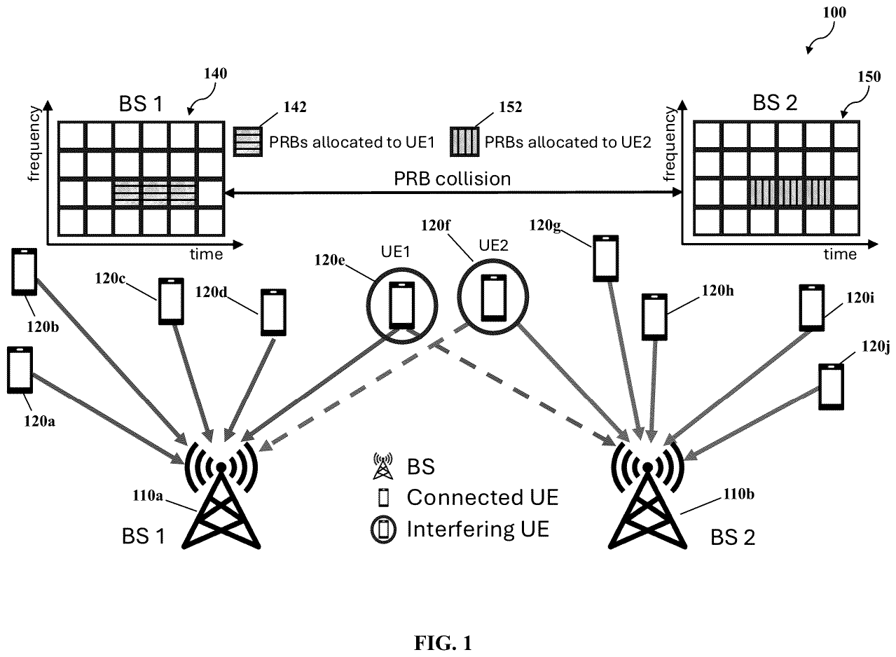

With the foregoing in mind, FIG. 1 is a block diagram illustrating an example wireless communication system or network 100 with a shared transmission medium. Network 100 includes one or more network nodes 110 such as a base station that can be configured to support data exchanges with one or more UEs 120 in accordance with a wireless communication standard. In the context of wireless communication systems or networks, a base station can also be referred to as gNBs, an access point, and the like. In an embodiment, the wireless communication standard can be implemented using any communication standard related to the Third Generation Partnership Project (3GPP) such as the 5G cellular technology standard, the sixth generation (6G) cellular technology standard, and the like. In an embodiment, the wireless communication standard can be implemented using any communication standard in the Institute of Electrical and Electronics Engineers (IEEE) 802.11 family of communication standards.

Devices, such as network nodes 110 and UEs 120, can operate in accordance with the wireless communication standard of network 100 to establish links over different channels of the shared transmission medium to exchange data with other wireless devices in the form of packets or messages. Each channel can include a bandwidth that generally represents a range of frequencies within a given band of a radio frequency (RF) spectrum. Links may be established between wireless devices in network 100 over channels in different frequency bands of the RF spectrum. Each UE 120 can operate at a corresponding link to transmit data in a direction (e.g., uplink) from the UE 120 to a network node 110. Each UE 120 can also operate at a corresponding link to receive data in a direction (e.g., downlink) from a network node 110 to the UE 120.

Network nodes 110 can manage transmissions over the shared transmission medium of RAN 100 using frame structures or resource grids 130. Frame structure 130 includes a number of resource elements 132. Each resource element 132 generally represents a smallest time-frequency resource available for transmissions over the shared transmission medium of RAN 100. Network nodes 110 can allocate resource elements 132 to UEs 120 for uplink transmissions in a manner that avoids collisions or simultaneous transmissions from two or more UEs 120 using the same resource element 132.

RAN 100 can support data exchanges with UEs 120 within a certain geographic area. In a multi-node deployment of RAN 100, each network node 110 (e.g., a base station or gNB) of RAN 100 can support data exchanges with UEs 120 within a subset of the geographic area that can be referred to as a “cell.” In FIG. 1, network node 110a (or base station 1) can support data exchanges with UEs 120a-120e within one cell of RAN 100 and network node 110b (or base station 2) can support data exchanges with UEs 120f-120j in another cell of RAN 100. The respective cells of network nodes 110a and 110b can represent neighboring or adjacent cells within the multi-node deployment of RAN 100.

Similar to real-word cellular topologies with increasing densification, network nodes 110a and 110b can be configured to operate within overlapping frequency bands. For example, network node 110a can be configured to operate within a frequency band that overlaps with a frequency band used by network node 110b. FIG. 1 illustrates that in-band or inter-cell uplink interference can occur when unwanted transmissions from UEs operating within an overlapping frequency band (e.g., the same frequency band) but connected to different base station or gNB, interferes with uplink reception of a serving base station or gNB. The in-band or inter-cell uplink interference in FIG. 1 is represented by a physical resource block (PRB) collision. With network nodes 110a and 110b being configured to operate within overlapping frequency bands, a PRB collision can occur when network node 110a allocates REs 132a to UE 120f (or UE1) that overlaps in the frequency domain and/or the time domain with REs 132b that network node 110b allocates to UE 120g (or UE2).

Such an overlap can significantly degrade the UL Signal to Interference plus Noise Ratio (SINR) at the affected network node, potentially leading to unrecoverable packets and thus reduced network performance. In-band or inter-cell interference can be particularly significant when UEs are located at the cell edge, where overlapping regions between two neighboring cells force the devices to increase their transmit power to overcome the link budget constraints. In such cases, the unpredictability of potential in-band UL interference can be associated with UE power control. Similarly, UEs can transmit at excessive power levels to compensate for signal degradation when experiencing Non-Line-of-Sight (NLOS) conditions with respect to their serving node. While this adjustment helps maintain reliable links, it can also lead to unintended interference in adjacent cells. Moreover, in scenarios involving directional UE transmissions, as in millimeter wave links, beamforming can introduce an additional source of unpredictability. For example, beamforming can impact adjacent cells through strong sidelobes, or, under highly dynamic conditions, even affect them with the main lobe. These conditions are often unknown a priori (e.g., at scheduling time), and can vary on timescales faster than a subframe (e.g., sub-ms). Real-time interference detection can facilitate a prompt reaction across the protocol stack of a RAN.

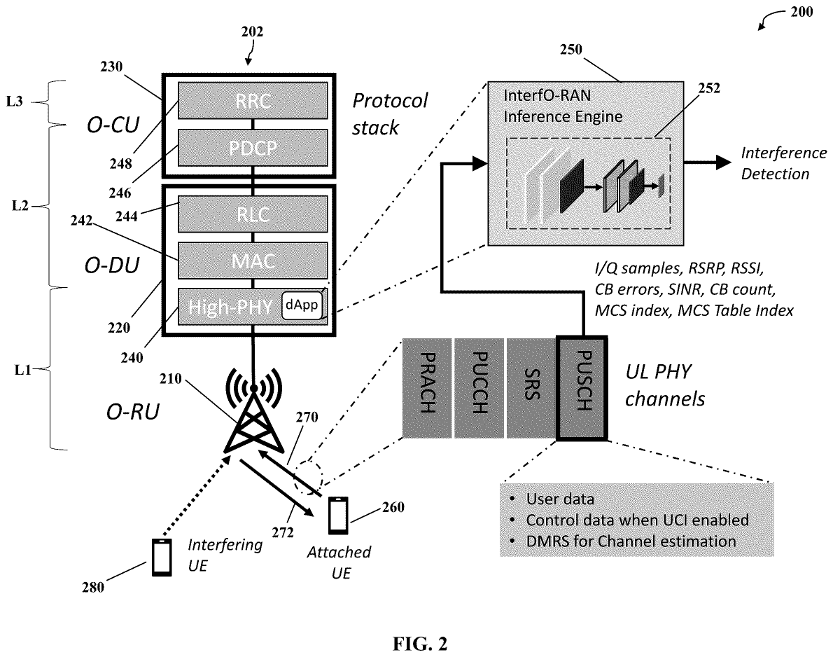

FIG. 2 is a block diagram illustrating an example radio access network (RAN) 200 with in-band or inter-cell uplink interference detection, in accordance with aspects of the present disclosure. In FIG. 2, RAN 200 has an O-RAN architecture such that a protocol stack 202 of RAN 200 can be distributed across multiple nodes or elements of RAN 200. RAN 200 includes a radio unit (RU) 210, a distributed unit (DU) 220, and a central unit (CU) 230. Layer 1 of protocol stack 202 can be distributed between RU 210 and DU 220. RU 210 can implement or execute low-PHY functions in Layer 1 of protocol stack 202 such as Fast Fourier Transform (FFT) functions, Inverse Fast Fourier Transform (iFFT) functions, cyclic prefix (CP) addition/removal functions, and other low-PHY functions. DU 220 can implement or execute high-PHY functions 240 in Layer 1 of protocol stack 202 of RAN 200 such as forward error correction (FEC) encoding/decoding functions, multiple-input multiple-output (MIMO) layer mapping functions, and other high-PHY functions 240.

Layer 2 of protocol stack 202 can be distributed between DU 220 and CU 230. DU 220 can implement or execute MAC functions 242 in Layer 2 of protocol stack 202 such as PC functions, RA functions, quality of service (QoS) functions, and other MAC functions 242. DU 220 can also implement or execute RLC functions 244 in Layer 2 of protocol stack 202 such as duplicate detection functions, automatic repeat request (ARQ) error correction functions, and other RLC functions 246. CU 230 can implement or execute PDCP functions 246 in Layer 2 of protocol stack 202 such as dual connectivity data splitting functions, encryption/decryption functions, and other PDCP functions 246. CU 230 can also implement or execute RRC functions 248 in Layer 3 of protocol stack 202 such as radio bearer control functions, mobility management functions, and other RRC functions 248.

In FIG. 2, a UE (“Attached UE”) 260 has attached or connected to RU 210. A link 270 is established over a shared transmission medium of RAN 200 to support uplink transmissions that propagate from Attached UE 260 towards RU 210. A link 272 is established over the shared transmission medium of RAN 200 to support downlink transmissions that propagate from RU 210 to Attached UE 260. Unwanted transmissions from an interference source operating within a frequency band that overlaps with a frequency band associated with link 270 can create or contribute to interference on link 270. Unwanted transmissions from an interference source operating within a frequency band that overlaps with a frequency band associated with link 272 can create or contribute to interference on link 272. In FIG. 2, Interfering UE 280 operates within a frequency band that overlaps with a frequency band associated with link 272. Unwanted transmissions 282 from Interfering UE 280 can create or contribute to interference on link 270, such as in-band or inter-cell uplink interference. For example, where RU 210 and Attached UE 260 correspond to base station 110a and UE 120e of FIG. 1, respectively, Interfering UE 280 corresponds to UE 120f of FIG. 1. Another example, where RU 210 and Attached UE 260 correspond to base station 110b and UE 120f of FIG. 1, respectively, Interfering UE 280 corresponds to UE 120e of FIG. 1.

Within the distributed protocol stack 202 of RAN 200, features and capabilities of RAN 200 can be extended with custom logic that interfaces with different network functions operating in different layers of protocol stack 202 to, for example, implement control loops for inference, control, and classifications. Interference detection model 250 is integrated within high-PHY functions 240 in Layer 1 of protocol stack 202 to extend the features and capabilities of RAN 200. Interference detection model 250 can be implemented as a distributed application (dApp) to integrate within high-PHY functions 240 in Layer 1 of protocol stack 202. Generally, dApps are distributed applications that are configured to bring intelligence to CUs and DUs (e.g., DU 220 and CU 230) to facilitate real-time inference and control loops operating at real time (e.g., sub-10 ms timescales. dApps can complement xApps that operate at near-real-time (e.g., between 10 ms and 1 s) timescales on a Near-Real-Time RAN Intelligent Controller (RIC). dApps can also complement rApps that operate at non-real-time (e.g., at least 1 s) timescales on a Non-Real-Time RIC.

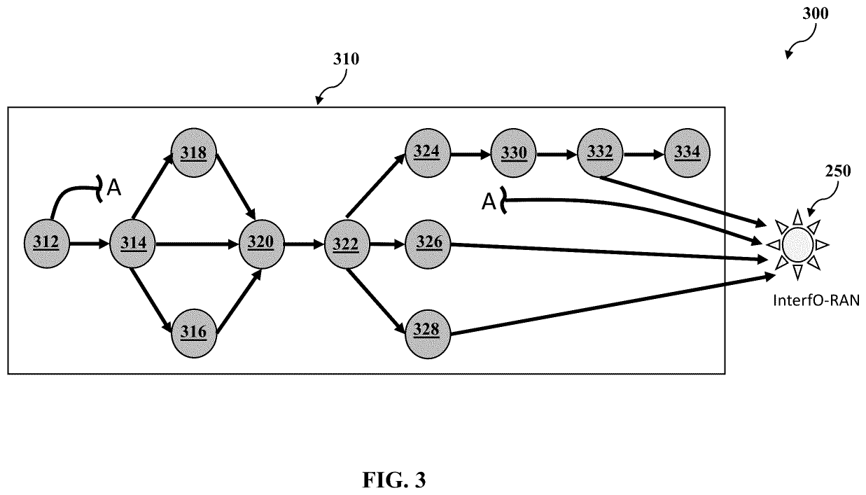

Protocol stack 202 can be a graphics processing unit (GPU)-based protocol stack to implement a GPU-accelerated framework (GPU-PHY framework) for physical layer processing in RAN 200. As described in greater detail below with reference to FIG. 3, a GPU-PHY framework generally refers to a signal processing pipeline within a PHY layer of a RAN's protocol stack that uses resources of a GPU or other parallel processing unit (PPU) for inline acceleration of resource-intensive tasks within the PHY layer. In an embodiment, a GPU-PHY framework can operate with slot-level granularity where each slot lasts about 500 microseconds (μs), aligned with a subcarrier spacing of about 30 kHz.

Processing circuitry of DU 220 executing high-PHY functions 240 can include a central processing unit (CPU) or other general-purpose processor and a GPU or other PPU. The CPU and the GPU can be physically separate devices in the processing circuitry of DU 220. By implementing a GPU-PHY framework in RAN 200, the processing circuitry of DU 220 can offload resource-intensive tasks associated with high-PHY functions 240 from its CPU or general-purpose processor to its GPU or other PPU for acceleration of the resource-intensive tasks. Resource-intensive tasks associated with high-PHY functions 240 can include forward error correction (FEC) encoding/decoding functions, multiple-input multiple-output (MIMO) layer mapping functions, and other high-PHY functions 240.

Implementing interference detection model 250 as a dApp executing on processing circuitry of DU 220 can provide interference detection model 250 with programmable real-time (e.g., sub 1 ms) access to user plane data associated with PHY layer processing in RAN 200. As a dApp executing on processing circuitry of DU 220, interference detection model 250 can also access control data at DU 220 such as downlink control information (DCI) and uplink control information (UCI) when enabled. Interference detection model 250 can access such data associated with PHY layer processing in RAN 200 to detect in-band or inter-cell uplink interference such as the interference on link 270 associated with unwanted transmissions 282 from Interfering UE 280.

Interference detection model 250 can be configured to detect in-band or inter-cell interference in links established over a shared transmission medium of RAN 200. FIG. 2 shows that interference detection model 250 can detect in-band or inter-cell uplink interference using samples of in-phase and quadrature (I/Q) data from an uplink transmission slot and observation data generated for the uplink transmission slot. Observation data generally refers to key performance measurement (KPM) data, key performance indicator (KPI) data, and other measurement or observation data indicative of an operational state of RAN 200. Examples of observation data include data indicative of physical resource block (PRB) allocation, modulation and coding scheme (MCS) selection, round trip time (RTT), network peak-to-average power ratio (PAPR), transmission power, received signal strength indicator (RSSI), reference signal, signal-to-noise ratio (SNR), signal-to-noise and interference ratio (SINR), received quality (RSRQ), received signal to noise indicator (RSNI), reference signal received power (RSRP), received signal code power (RSCP), received channel power indicator (RCPI), MCS index, MCS table index, total count of code block (CB) errors, number of CBs, and other measurement or observation data indicative of an operational state of a communication network.

I/Q or baseband data that interference detection model 250 uses for in-band or inter-cell uplink interference detection can be referred to as “raw I/Q data” or “pre-equalization I/Q data” because or baseband data (e.g., PUSCH I/Q samples) because interference detection model 250 ingests samples of I/Q data from an uplink transmission slot without any processing such as equalization, demodulation, or decoding. Observation data that interference detection model 250 uses for in-band or inter-cell uplink interference detection can be referred to as “synchronous observation data” or “contemporaneous observation data” because interference detection model 250 ingests raw I/Q data and observation data from the same uplink transmission slot to detect in-band or inter-cell uplink interference.

Interference detection model 250 includes a neural network (NN) 252 that processes samples of raw I/Q data from an uplink transmission slot and synchronous observation data. NN 252. As described in greater detail below with reference to FIGS. 3-5, customized functions known as kernels executing on a GPU or other PPU for PHY layer processing provide samples of raw I/Q data and synchronous observation data as input to NN 252 such that interference detection model 250 does not interfere with ongoing PHY layer processing.

In FIG. 2 illustrates an embodiment of interference detection model 250 that is configured to detect in-band or inter-cell uplink interference using physical uplink shared channel (PUSCH) data. Generally, PUSCH is an uplink channel that 5G or B5G RANs primarily use for data transmission. PUSCH transmissions can be dynamically scheduled by a base station or gNB of a RAN that allocates frequency and time resources based on real-time network conditions. The base station can signal resource allocation to UEs through DCI messages that specify parameters such as MCS, resource block allocation, and transmission power.

In other embodiments, interference detection model 250 can be configured to detect in-band or inter-cell uplink interference using data from other uplink channels or signals, such as a physical uplink control channel (PUCCH), a physical random access channel (PRACH), and a sounding reference signal (SRS). In such embodiments, interference detection model 250 can be configured to detect in-band or inter-cell uplink interference using data from the other uplink channels or signals instead of or in addition to PUSCH channel data.

As described above, interference detection model 250 can be configured to interface with a GPU-PHY framework for physical layer processing. A GPU-PHY framework can include various components such as a PHY controller. A PHY controller can be configured to coordinate PHY layer processing by, for example, initializing GPU resources and creating an initial context for one or more PHY layer connections (e.g., RU connections in an O-RAN architecture). During over-the-air (OTA) uplink and/or downlink transmissions, a L2 adapter within the PHY controller can translate control plane messages (e.g., control plane messages from the Small Cell Forum (SCF) Functional Application Platform Interface (FAPI) interface) into slot commands to configure the PHY layer for uplink and/or downlink transmissions of PHY-layer data traffic. Slot commands can be processed by the PHY controller, converted into tasks, and assigned to specific uplink/downlink channel worker threads. The PHY controller can map slot commands to appropriate central processing unit (CPU) cores, these threads delegate computational tasks to the GPU. Each uplink/downlink channel worker thread generally represents a particular physical channel process implemented as a pipeline, with operations executed as functions (“kernels”) that are configured to execute in parallel on a GPU or other PPU. The pipeline can be supported by one or more application programming interfaces (APIs) provided by a PHY library that can be invoked by the PHY controller to manage creation, configuration, and/or execution of kernels.

Uplink processing in a protocol stack of a RAN can start with slot configuration from a network function that operates in an L2 layer (e.g., L2 layer of protocol stack 202 in FIG. 2) the protocol stack and can end with uplink signal processing in an L1 layer (e.g., L1 layer of protocol stack 202 in FIG. 2) of the protocol stack. A GPU-PHY framework can implement a PUSCH channel as a pipeline (e.g., PUSCH channel pipeline 300), for operations such as Resource Element (RE) de-mapping, channel estimation, channel equalization, de-rate matching, de-layer mapping, de-scrambling, LDPC decoding, and Cyclic Redundancy Check (CRC) checks for both code blocks (CBs) and Transport Blocks (TBs). The GPU-PHY framework can also execute uplink control indication (UCI) processing on PUSCH and transform precoding, if enabled, using individual kernels. The GPU-PHY framework can also manage timing advance (TA) and carrier frequency offset (CFO) using specialized kernels.

A GPU-PHY framework can optimize PUSCH pipeline 300 using an acyclic graph structure 310 where nodes correspond to kernels and edges define inter-dependencies of the kernels, as illustrated in FIG. 3. Acyclic graph structure 310 includes root node kernel 312, channel estimator kernel 314, CFO/TA estimator kernel 316, noise/interference estimator kernel 318, equalizer coefficients kernel 320, fused equalizer and soft-demapper kernel 322, rate de-matching kernel 324, RSSI kernel 326, RSRP kernel 328, LDPC decoder kernel 330, CB CRCs kernel 332, and TB CRCs kernel 334.

FIG. 3 illustrates that interference detection model 250 can be embedded as a functional plugin in a GPU-PHY framework. Interference detection model 250 can execute in-line with processing of a PHY layer following execution of PUSCH pipeline 300 to detect in-band or inter-cell interference, as illustrated by FIG. 3. Implementing interference detection model 250 as a post-processing unit following PUSCH pipeline 300 can facilitate in-band or inter-cell interference detection without affecting ongoing processes of PUSCH pipeline 300. As a post-processing unit, interference detection model 250 can access information available across different processing steps of PUSCH pipeline 300 without interfering with real-time processing constraints associated with a PHY layer of a base station. FIG. 3 illustrates interference detection model 250 ingesting samples of raw I/Q data and synchronous observation data extracted from root node kernel 312, RSSI kernel 326, RSRP kernel 328, and CB CRCs kernel 332.

The graph-based architecture of acyclic graph structure 300 can facilitate management of dependencies within acyclic graph structure 310 by delineating the intricate workflow of kernel operations. Acyclic graph structure 310 also provides a unified entity that facilitates concurrent launch of all kernels associated with PUSCH pipeline 300 such that a GPU can autonomously oversee the execution process of the kernels, thereby reducing any necessity for continuous CPU intervention. The graph-based architecture of acyclic graph structure 300 enhances temporal efficiency of PUSCH pipeline 300 by reducing or minimizing launch overhead that corresponds to a latency associated with initiating kernels of PUSCH pipeline 300.

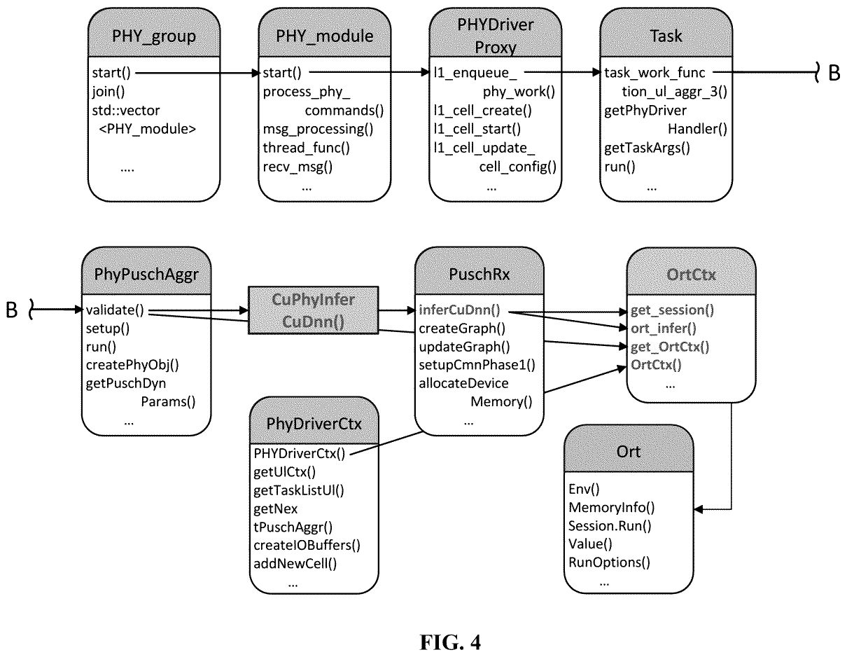

FIG. 4 illustrates an example workflow diagram 400 for integrating in-band or inter-cell uplink interference detection within a GPU-PHY framework, in accordance with aspects of the present disclosure. Workflow diagram 400 includes function CuPhyInferCuDnn( ), a customized API that can be hosted by a GPU-PHY framework and managed by PHY controller of the GPU-PHY framework. The customized API (i.e., Function CuPhyInferCuDnn( )) can provide interference detection model 250 with access information available across different processing steps of PUSCH pipeline 300 without interfering with real-time processing constraints associated with a PHY layer of a base station. The customized API can also employ a Session. Run( ) method from a deep learning framework (“ORT”) to execute in-band or inter-cell uplink interference detection by interference detection model 250. To reduce or mitigate interference detection model 250 interfering with the tightly time-coupled operations of the PUSCH or other channels, the PHY controller can delegate interference detection-related processing to a newly instantiated and independent CPU thread. This thread is assigned to a dedicated CPU core—isolated from other operations—to improve stability.

During an initial call to Session. Run( ), ORT can perform several setup steps, such as: (i) memory allocation for model tensors; (ii) graph optimization and compilation to ensure efficient runtime execution; (iii) execution provider setup, such as configuring the GPU-PHY framework for GPU inference; and (iv) caching mechanisms for future executions. Once initialized, the setup steps can be cached such that subsequent invocations to bypass the preparatory steps and run significantly faster.

Interference detection model 250 can perform an initial warm-up inference before the base station becomes operational. During, a preliminary inference step can be performed on dummy data encompassing all input features. Then a pointer to the ORT run session (already initialized) is passed to interference detection model 250. To support this, interference detection model 250 can be encapsulated within a customized ORT context class, OrtCtx, which can be instantiated within a PHY driver context class, PhyDriverCtx, as illustrated in FIG. 4. This manages instances of transmit and receive processing pipelines for UL and DL slots, as well as individual classes corresponding to each PHY channel, among others. Additionally, it handles the allocation of GPU resources and manages the GPU footprint for all UL and DL executions. PhyDriverCtx can be instantiated as the whole PHY instance starts to facilitate executing the initial warm-up inference before the base station becomes operational.

As part of this process, an OrtCtx class constructor initializes and configures the dynamically allocated instance of an ORT inference session as a smart pointer, using the native ORT API and leveraging its comprehensive classes and methods, as shown in FIG. 4. The process starts with creating an Ort::Env( ) object for logging and runtime management, followed by configuring session options for optimization, including graph processing, threading, memory allocation, and GPU-specific settings for CUDA and Ten-sorRT. The dummy input data for warm-up inference is allocated in CPU memory and transferred to the GPU for execution, encapsulated as Ort::Value( ) tensors. Session. Run( ) processes the data through the pre-trained ONNX model and generates output tensors containing class probabilities, selecting the highest probability as the final prediction.

Upon initialization, the OrtCtx object is passed to the PUSCH channel via the physical PUSCH aggregate class, PhyPuschAggr, and invoked during the validation phase as a callable function, get_OrtCtx( ). This validation phase is a post-processing step always executed after the PUSCH pipeline. Inference in the PUSCH pipeline 300 is orchestrated by inferCuDnn( ), a member of PuschRx class, and invoked by CuPhyInferCuDnn( ) API, as illustrated in FIG. 4. It retrieves the inference session from the OrtCtx object via get_session( ), reusing the session configuration and runtime environment. Input features for interference detection model 250 can be encapsulated into ONNX-compatible tensors using ort_infer( ), using GPU memory for CUDA/TensorRT or CPU memory otherwise. When performing inference on the GPU, the input features are transferred directly within GPU memory without overhead. Tensors follow predefined shapes and types, with input/output names built dynamically for runtime flexibility.

In an embodiment, interference detection model 250 is configured to perform automated data collection to create datasets for offline model training. The automated data collection can leverage a CuPhyInfer-CuDnn( ) API to stream data into a Hierarchical Data Format version 5 (HDF5) file at a frequency of one every 10 UL slots. Different from what happens for online inference, the API asynchronously transfers features to be stored from GPU to CPU and writes to disk thereafter. This avoids many operations that would otherwise be required on GPU, including data conversion to tensors and subsequent GPU memory deallocation. Besides, to avoid interference with the tightly coupled operations of PUSCH or other channels, the PHY controller can delegate data logging to a newly instantiated CPU thread operating in detached mode, ensuring uninterrupted processing. In an embodiment, TF's sequence class can implement a custom data generator to efficiently manage GPU memory during offline training. The custom data generator can dynamically load small batches of data from a training dataset into GPU memory, rather than loading the entire training dataset at once, thereby optimizing memory usage and avoiding excessive memory strain.

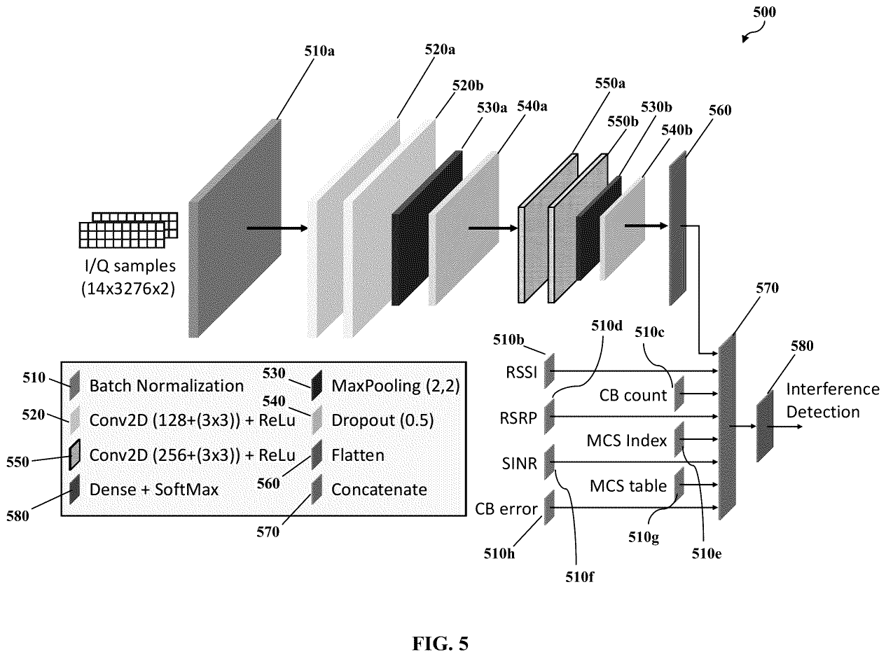

FIG. 5 is a diagram illustrating an example neural network architecture 500, in accordance with aspects of the present disclosure. In some embodiments, implementing neural network 252 of FIG. 2 using an architecture such as NN architecture 500 can configure neural network 252 to identify complex patterns in incoming UL data such as raw or pre-equalization I/Q or baseband data (e.g., PUSCH I/Q samples) from an uplink transmission slot and observation data generated for the uplink transmission slot to facilitate real-time (e.g., less than 10 ms) interference classification using a data-driven methodology.

NN architecture 500 includes seven layers. In NN architecture 500, batch normalization layer 510a receives samples of raw I/Q data (e.g., PUSCH I/Q samples) from an uplink transmission slot for normalization and conversion into fixed-size tensor formats. Normalizing and converting samples of raw I/Q data into fixed-size tensor formats can facilitate compatibility of heterogeneous numerical formats such as float16 (e.g., for I/Q data) across deep learning frameworks and GPU-accelerated 5G or 6G signal processing frameworks.

Two convolutional blocks of NN architecture 500 perform feature extraction at an output side of batch normalization layer 510a. Each convolutional block of NN architecture 500 contains two two-dimensional (2D) convolutional (Conv2D layers). FIG. 5 illustrates a first convolutional block of NN architecture 500 as including Conv2D layers 520a and 520b (128 filters, 3×3 kernel, ReLU activation) and one 2×2 MaxPooling layer 530a. FIG. 5 also illustrates a second convolutional block of CNN architecture 500 as including Conv2D layers 550a and 550b (256 filters, 3×3 kernel, ReLU activation) and one 2×2 MaxPooling layer 530b. Features extracted using the two convolutional blocks of NN architecture 500 can be flattened at flattening layer 560 for input to concatenation layer 570.

In NN architecture 500, batch normalization layer(s) 510b-h receive synchronous observation data for normalization and conversion into fixed-size tensor formats. Normalizing and converting observation data into fixed-size tensor formats can facilitate compatibility of heterogeneous numerical formats, such as float32 (e.g., for RSSI, RSRP, SINR), and int32 (e.g., for MCS and CB inputs), across deep learning frameworks and GPU-accelerated 5G or 6G signal processing frameworks. Batch normalization layer(s) 510b-h provide synchronous observation data as normalized structured inputs to concatenation layer 570 for concatenation with the flattened extracted features of raw I/Q data samples output at flattening layer 560.

A fully connected dense layer 580 with softmax activation can process the output of concatenation layer 570 to generate an in-band interference indication for the uplink transmission slot. The in-band interference indication output by dense layer 580 is for the same uplink transmission slot that sources the samples of raw I/Q data that batch normalization layer 510a receives. The in-band interference indication output by dense layer 580 is also for the same uplink transmission slot that the synchronous observation data was generated from, and which drives the input of batch normalization layer(s) 510b-h.

FIG. 5 illustrates that NN architecture 500 can include dropout layers (e.g., dropout layers 540a and 540b) and L2 regularizers (e.g., MaxPooling layers 530a and 530b) to enhance generalization and mitigate overfitting. Dropout layers can randomly deactivate neurons during training, encouraging a model to learn underlying patterns rather than memorizing training data. L2 regularizers can penalize large weights, promoting simpler, more generalized models. NN architecture 500 can use a weighted loss function instead of a standard loss function to address class imbalances (e.g., in case of data collections with different number of samples for different radios, or interference conditions). Standard loss functions generally tend to favor the majority class. In contrast, weighted loss functions generally assign greater weights to a minority class to ensure that contributions of the minority class have a stronger influence on the overall loss computation.

As discussed above, implementing neural network 252 of FIG. 2 using an architecture such as NN architecture 500 can facilitate processing raw I/Q data directly and incorporating additional features (e.g., synchronous observation data) to improve classification accuracy relative to other approaches that use heatmaps of I/Q samples for interference detection. In an embodiment, raw I/Q data are extracted prior to the Minimum Mean Square Error (MMSE)-Interference Rejection Combining (IRC) equalizer, which is designed to mitigate channel distortion and interference. This pre-equalization extraction facilitates providing an unaltered view of interference effects, allowing for more accurate analysis. In an embodiment, samples of raw I/Q data (e.g., PUSCH channel I/Q samples) can be stored as 32-bit words (with two 16 bits floats for each component), in blocks of 14×273×12 contiguous words, where 14 is the number of symbols per slot, 273 is the maximum number of Physical Resource Blocks (PRBs) with 12 subcarriers each. In an embodiment, samples of raw I/Q data can be converted into a matrix with dimensions 14, 3276, 2, to align with an expected format of a deep learning framework for inference, with the third dimension being interpreted as the real and imaginary components of the I/Q data samples.

In an embodiment, one or more input features are transformed to ensure data compatibility. For example, in native CB-CRC kernel 332 of FIG. 3, CB errors for each physical channel (e.g., a PUSCH channel) are output as an array, where each non-zero value represents a corrupted CB within the TB, resulting in a dynamic size. In an embodiment, a learning model such as interference detection model 250 can have fixed-size input requirements. To meet the fixed-size input requirements of the learning model, two additional variables can be added for GPU processing: one to determine the number of corrupted CBs in a TB and another to find the total number of CBs. In an embodiment, operations corresponding to the two additional variables can be seamlessly integrated into CB CRCs kernel 332 of FIG. 3.

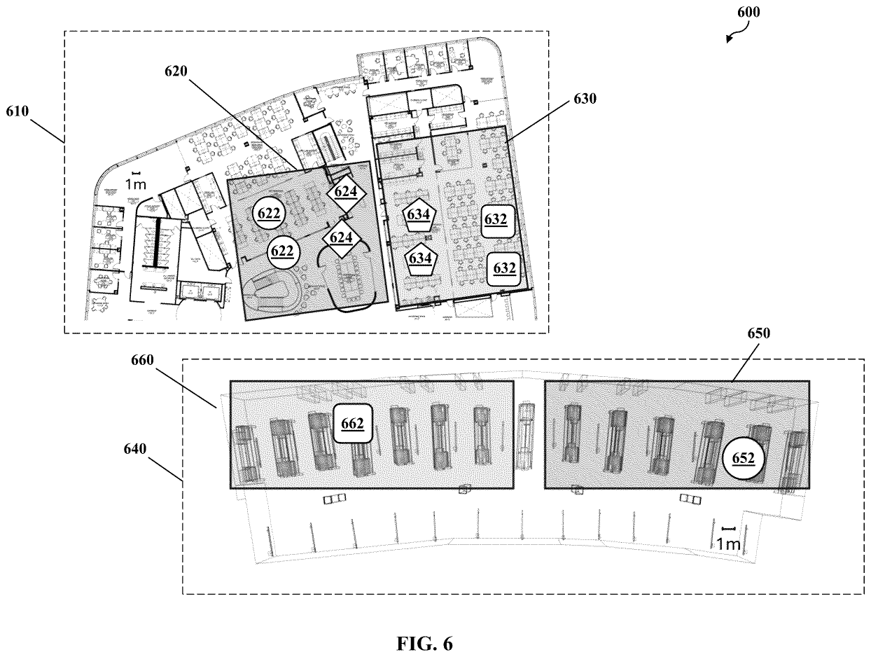

Interference detection models such as interference detection model 250 can be trained using observed or non-synthetic training data obtained by operating a RAN in diverse radio frequency (RF) environments with different channel conditions to facilitate real-world data collection. FIG. 6 is a block diagram illustrating an example RAN 600 operating in diverse RF environments with different channel conditions, in accordance with aspects of the present disclosure. In FIG. 6, RAN 600 has an O-RAN architecture with a distributed protocol stack like protocol stack 202 in RAN 200 of FIG. 2. RF environments 610 and 640 represent the diverse RF environments with different channel conditions in FIG. 6.

RAN 600 features a multi-node deployment with neighboring or adjacent cells in each RF environment. RF environment 610 includes multiple RUs 622 that support data exchanges with multiple UEs 624 in cell 620. RF environment 610 also includes multiple RUs 632 that support data exchanges with multiple UEs 634 in cell 630. RF environment 640 includes RU 652 that supports data exchanges with UEs in cell 650. RF environment 640 also includes RU 662 that supports data exchanges with UEs in cell 660. To mimic real-word cellular topologies with increasing densification, RUs in neighboring or adjacent cells are configured to operate within overlapping frequency bands. For example, RUs 622 in cell 620 are configured to operate within a frequency band that overlaps with a frequency band used by RUs 632 in cell 630. Another example, RU 652 in cell 650 is configured to operate within a frequency band that overlaps with a frequency band used by RU 662 in cell 660.

Generating observed or non-synthetic training data for RAN 600 involves UEs in each cell connecting to a RU that supports data within the corresponding cell under line-of-sight (LOS) and non-line-of-sight (NLOS) channel conditions. Each data collection session includes a RU interacting with UEs in its respective cell under three different operational scenarios. In a “No UE” scenario, no UEs in a cell of a RU have connected to or established links with the RU. In a “No Traffic” scenario, one or more UEs in a cell of a RU have connected to the RU and remains attached or connected to the RU while exchanging minimal control information for maintaining connection stability. In a “High Traffic” scenario, one or more UEs in a cell of a RU are connected to the RU and generate uplink transmissions signals to the RU that are sufficiently strong to interfere with neighboring cells. The “High Traffic” and “No Traffic” scenarios can have different TB sizes to improve interference identification accuracy. For example, a TB size of a “No Traffic” scenario is typically around 185 bytes and generally does not exceed 1056 bytes, with the number of CBs limited to one. Another example, a TB size of a “High Traffic” scenario typically exceeds 1056 bytes, and the number of CBs is greater than one.

Interference detection models such as interference detection model 250 can also be trained using synthetic training data obtained using simulation software to simulate RAN operations. Simulating RAN operations can include link-level simulations that perform end-to-end simulation of a single link or point-to-point connection in a RAN, including transmitter, channel modeling, and receiver operations. Simulating RAN operations can also include system-level simulations that model a RAN with multiple base stations and UEs interacting simultaneously. Simulating RAN operations can involve sweeping or varying different parameters, such as SNR, SIR, MCS index, channel type, delay profile, interference channel delay profile, numerology, and carrier frequency, and the like. Simulating RAN operations can also involve artificially generating an in-band interference signal to simulate interference by transmitting Orthogonal Frequency Division Multiplexing (OFDM) signals from multiple antennas independently through a Tapped Delay Line (TDL) channel characterized by high delay spread and Doppler shift. These conditions can emulate a dynamic and realistic environment affected by multipath propagation and high mobility, thus creating a robust testbed for interference mitigation. An artificially generated in-band interference signal can be multiplied by a modified all-zero matrix with randomly distributed contiguous ones, introducing localized and burst interference in REs of an OFDM slot. Multiplying the artificially generated in-band interference signal by the modified all-zero matrix can introduce random patterns for contiguous ones across antenna streams while maintaining the average power of the interference signal.

Embodiments of the present disclosure can employ transfer learning using heterogeneous datasets from diverse RF environments to enhance model generalization capabilities. Generally, transfer learning refers to a machine learning technique wherein knowledge acquired from a source domain is leveraged to improve performance on a target domain through model adaptation. In an embodiment, transfer learning can be used to implement interference detection model 250 by training a baseline or foundational interference detection model on training data from diverse RF environments or multiple deployment locations. In an embodiment, the training data from diverse RF environments or multiple deployment locations can include one or more of observed training data and synthetic training data. In an embodiment, the baseline interference detection model can be constructed using source training data obtained from a source RF environment. For example, the source RF environment can be RF environment 610 and the source training data can be a subset of the observed training data obtained from RF environment 610.

In an embodiment, a customized interference detection model can be constructed for operating in a target RF environment using the baseline interference detection model and target source data specific to the target RF environment. Continuing from the previous example, the target RF environment can be RF environment 640 and the target source data can be a subset of the observed training data obtained from RF environment 640. Constructing a customized interference detection model can be useful for fine-tuning a baseline interference detection model for a specific deployment while retaining knowledge of diverse scenarios by preserving foundational feature representations and enhancing performance. In an embodiment, constructing the customized interference detection model can involve freezing or maintaining batch normalization layers of a NN of the baseline interference detection model while adjusting remaining layers of the NN for operating in the target environment using the target training data.

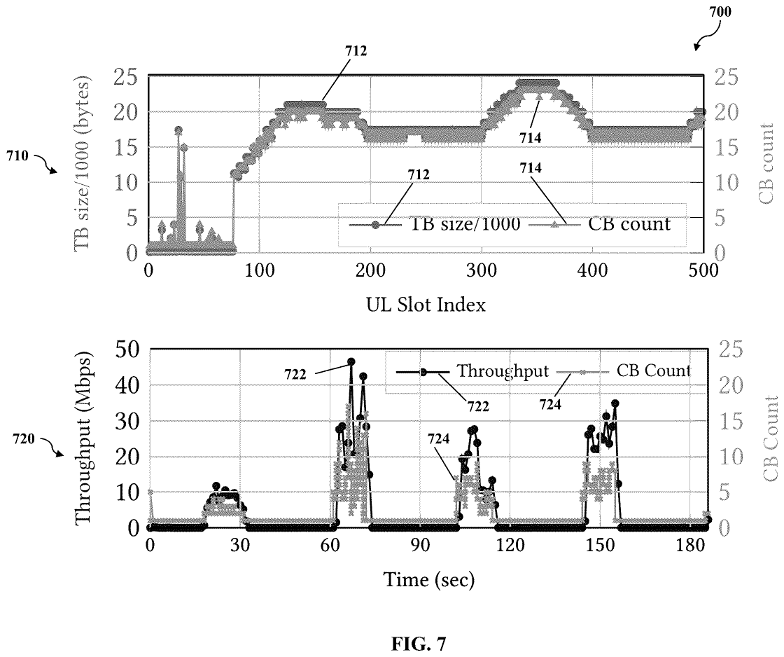

FIG. 7 is a diagram 700 that illustrates various example UL transmission scheduling parameters at a base station of RAN 600. Diagram 700 includes plot 710 with lines 712 and 714 that illustrate TB size reduced by a factor of 1000 in bytes and CB count, respectively, as a function of UL slot index. Plot 710 shows that a relationship exists (e.g., a strong correlation) between CB count and TB size. For example, CB count can increase responsive to increasing TB size and decrease responsive to decreasing TB size. Diagram 700 also includes plot 720 with lines 722 and 724 that illustrate UL throughput in megabytes per second (Mbps) and CB count, respectively, over time. Plot 720 shows that a relationship exists (e.g., a strong correlation) between UL throughput and CB count. For example, UL throughput can increase responsive to increasing CB count and decrease responsive to decreasing CB count. Diagram 700 shows that CB count can be useful for UL traffic interference classification to facilitate detection of in-band or inter-cell UL interference in wireless communication systems.

FIG. 8 is a table 800 of example labeling rules that facilitate training models (e.g., interference detection model 250 of FIG. 2) for detection of in-band or inter-cell uplink interference in wireless communication systems. In an embodiment, labeling rules of table 800 can be applied to samples of synthetic or observed UL transmission-related data to generate training data with classification information such as ground truth labels to train a model for detection of in-band or inter-cell uplink interference in wireless communication systems.

Table 800 includes UL transmission-related data for base stations or gNBs operating in adjacent or neighboring cells of a RAN. The UL transmission-related data of table 800 is characterized in accordance with the “No UE,” “No Traffic,” and “High Traffic” scenarios described above with reference to FIG. 6. In FIG. 8, binary interference indications or UL labels are applied to the UL transmission-related data for a UL transmission slot based on UL traffic levels in the adjacent or neighboring cells contemporaneous with the UL transmission slot. The binary interference indications include “INTERF” to classify the UL transmission-related data in a UL transmission slot that is affected by interference. The binary interference indications include “CLEAN” to classify the UL transmission-related data in a UL transmission slot that is unaffected by interference.

In accordance with one labeling rule of FIG. 8, the “INTERF” interference indication is applied to each cells' respective UL transmission-related data for a UL transmission slot when both adjacent cells experience “High Traffic” UL traffic levels during the same UL transmission slot. For example, FIG. 8 shows the “INTERF” interference indication applied to gNB1's and gNB2's respective UL transmission-related data when both gNB1 and gNB2 experience “High Traffic” UL traffic levels during the same UL transmission slot.

In accordance with another labeling rule of FIG. 8, the “CLEAN” interference indication is applied to each cells' respective UL transmission-related data for a UL transmission slot when both adjacent cells experience “No Traffic” UL traffic levels during the same UL transmission slot. For example, FIG. 8 shows the “CLEAN” interference indication applied to gNB1's and gNB2's respective UL transmission-related data when both gNB1 and gNB2 experience “No Traffic” UL traffic levels during the same UL transmission slot.

In accordance with yet another labeling rule of FIG. 8, the “CLEAN” interference indication is applied to one cell's UL transmission-related data for a UL transmission slot when the other cell experiences a “No UE” UL traffic level during the same UL transmission slot. Under such circumstances, the “CLEAN” interference indication is applied to the cell's UL transmission-related data for the UL transmission slot regardless of whether it experiences “High Traffic” or “No Traffic” UL traffic levels during the UL transmission slot. For example, FIG. 8 shows the “CLEAN” interference indication applied to gNB2's UL transmission-related data when gNB1 experiences a “No UE” UL traffic level during the same UL transmission slot. In this example, the “CLEAN” interference indication applied to gNB2's experiences “High Traffic” or “No Traffic” UL traffic levels during the UL transmission slot. Another example, FIG. 8 also shows the “CLEAN” interference indication applied to gNB1's UL transmission-related data when gNB2 experiences a “No UE” UL traffic level during the same UL transmission slot. In this example, the “CLEAN” interference indication applied to gNB1's experiences “High Traffic” or “No Traffic” UL traffic levels during the UL transmission slot.

In accordance with another labeling rule of FIG. 8, the “INTERF” interference indication is applied to one cell's UL transmission-related data for a UL transmission slot when that cell experiences a “No Traffic” UL traffic level during the UL transmission slot while the other cell experiences a “High Traffic” UL traffic level during the UL transmission slot. Under such circumstances, the “CLEAN” interference indication is applied to the other cell's UL transmission-related data that experiences the “High Traffic” UL traffic level during the UL transmission slot. For example, FIG. 8 shows the “INTERF” interference indication applied to gNB2's UL transmission-related data when gNB2 experiences a “No Traffic” UL traffic level during the UL transmission slot while gNB1 experiences a “High Traffic” UL traffic level during the UL transmission slot. In this example, the “CLEAN” interference indication is applied to gNB1's UL transmission-related data. Another example, FIG. 8 also shows the “INTERF” interference indication applied to gNB1's UL transmission-related data when gNB1 experiences a “No Traffic” UL traffic level during the UL transmission slot while gNB2 experiences a “High Traffic” UL traffic level during the UL transmission slot. In this example, the “CLEAN” interference indication is applied to gNB2's UL transmission-related data.

In an embodiment, a value of CB count for an UL transmission slot can be set to a threshold value (e.g., 1) to identify a “High Traffic” UL traffic level for one base station (e.g., gNB 1) during the UL transmission slot and to identify instances of interference in the UL transmission-related data on the other base station (e.g., gNB2) during the same UL transmission slot. Such thresholding mechanisms can be utilized to evaluate inference performance in OTA data scenarios by identifying UL transmission slots associated with “High Traffic” UL traffic level that can then be used to assign interference indications or ground truth labels (e.g., “CLEAN” or “INTERF”) to each sample of synthetic or observed UL transmission-related data, thereby facilitating the effective monitoring of spectrum sensing capabilities.

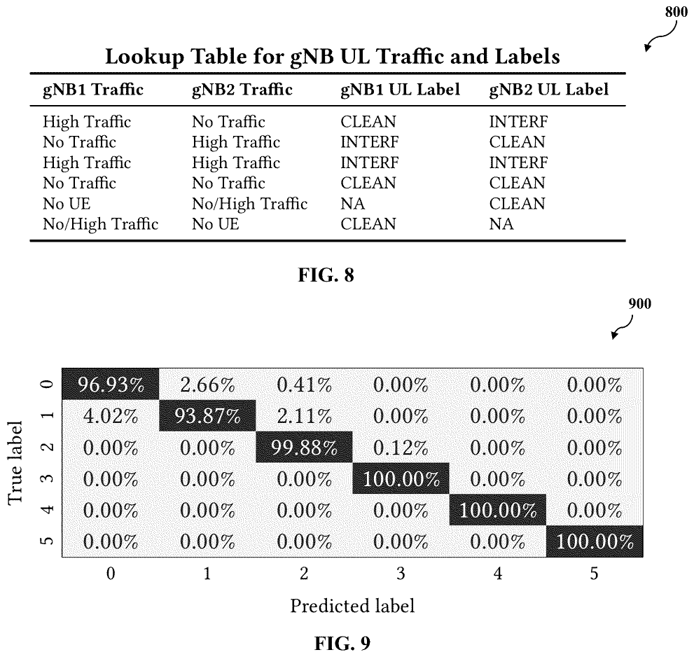

FIG. 9 is an example confusion matrix 900 that illustrates the impact of the number of interference sources on in-band or inter-cell uplink interference detection performance, in accordance with aspects of the present disclosure. Confusion matrix 900 shows that interference detection performance of an interference detection model (e.g., interference detection model 250 of FIG. 2) remains substantially consistent as the number of interference sources increases from 0 interference sources to 5 interference sources. For example, confusion matrix 900 shows that the accuracy of the interference detection model exceeds about 96% for scenarios with 0 interference sources and for scenarios with 2 or more interference sources. Another example, confusion matrix 900 shows that the accuracy of the interference detection model achieves an accuracy of about 93.87% for scenarios with one interference source.

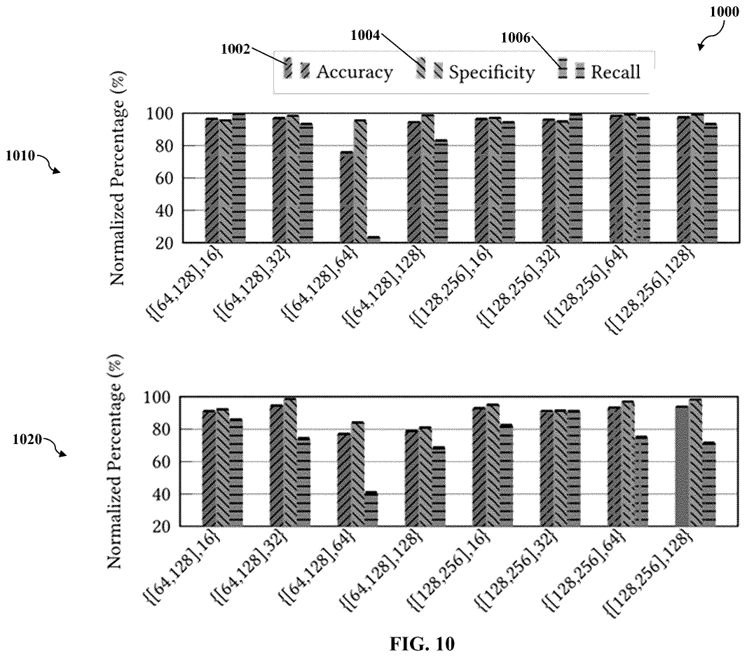

FIG. 10 is a diagram 1000 of example performance metrics for interference detection models with different neural network architectures operating in diverse RF environments, in accordance with aspects of the present disclosure. The example performance metrics in FIG. 10 include normalized percentage values of accuracy 1002, specificity 1004, and recall 1006 for each interference detection model. FIG. 10 represents the neural network architecture of each interference detection model as {[α, β], γ}, where α and β denote the number of filters in the first and second convolutional layers, respectively, and γ represents the batch size. FIG. 10 includes two configurations for [α, β] (i.e., [64, 128] and [128, 256]) to evaluate performance of relatively lightweight models. Diagram 1000 includes bar graph 1010 that illustrates in-band or inter-cell uplink interference detection performance of different interference detection models in a seen (or source) RF environment. Diagram 1000 also includes bar graph 1020 that illustrates in-band or inter-cell uplink interference detection performance of the different interference detection models in an unseen (or target) RF environment. Bar graph 1020 can be useful to evaluate generalization capabilities of the interference detection models.

In FIG. 10, the interference detection model with the {[128,256], 32} neural network architecture outperforms the other interference detection models with other neural network architectures. For example, the interference detection model with the {[128,256], 32} neural network architecture achieves performance metrics of about 96.12% accuracy, about 94.91% specificity, and about 99.30% recall in the seen (or source) RF environment. Another example, the interference detection model with the {[128,256], 32} neural network architecture achieves performance metrics of about 91.33% accuracy, about 90.96% specificity, and about 91.40% recall in the unseen (or target) RF environment.

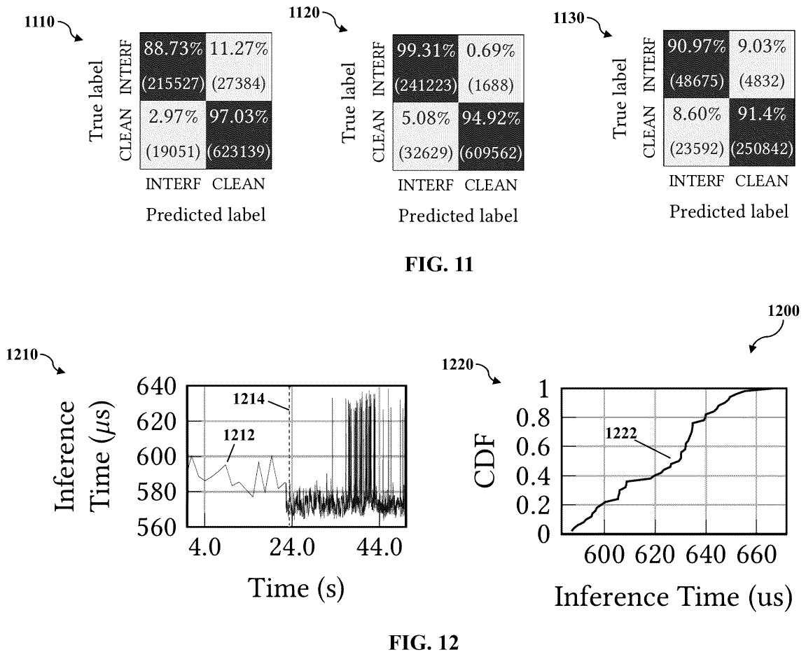

FIG. 11 is a diagram 1100 of example confusion matrices that illustrate the impact of transfer learning on in-band or inter-cell uplink interference detection, in accordance with aspects of the present disclosure. Diagram 1100 includes confusion matrix 1110 that illustrates in-band or inter-cell uplink interference detection performance of a baseline interference detection model operating in a seen or familiar RF environment. Diagram 1100 also includes confusion matrices 1120 and 1130 that illustrate in-band or inter-cell uplink interference detection performance of a TL interference detection model operating in a seen RF environment and in an unseen RF environment, respectively. A comparison between confusion matrices 1110 and 1120 shows that the TL interference detection model achieves overall better performance (e.g., ~+10.52%) in detecting interference when tested in the seen RF environment. A comparison between confusion matrices 1110 and 1130 shows that the TL interference detection model also achieves overall better performance (e.g., ~+2.24%) in detecting interference when tested in the unseen RF environment.

FIG. 12 is a diagram 1200 of example performance metrics that illustrate in-band or inter-cell uplink interference detection latency, in accordance with aspects of the present disclosure. Diagram 1200 includes plot 1210 with line 1212 that illustrates temporal variation of inference time in microseconds from first iteration over time for an example interference detection model (e.g., interference detection model 250 of FIG. 2). Plot 1210 uses a 5-instance moving average between a “No Traffic” scenario prior to time 1214 (e.g., about 24 seconds) and a “High Traffic” scenario after time 1214. Diagram 1200 also includes plot 1220 with line 1222 that illustrates a corresponding cumulative distribution function (CDF) for the interference detection model, as a function of the inference time in μs. Some fluctuations may be observed in plot 1210 during the “High Traffic” scenario after time 1214 when the interference detection model, performs interference at an increased frequency. Any such fluctuations may be associated with an increased number of operations related to performing interference at an increased frequency, GPU resource contention, and the like. Diagram 1200 shows that the wireless communication system maintains overall stability while effectively managing workload distribution.

GPU-accelerated interference detection with different configurations can have different average inference times. For example, varying filter counts of an interference detection model can change its average inference time. An interference detection model (e.g., interference detection model 250 of FIG. 2) configured with a filter count of {[64,128], any} can have an average inference time of about 401.8 μs. Increasing the filter count of the inference detection model from {[64,128], any} to {[128,256], any} can increase the average inference time from about 401.8 μs to about 621.6 μs. The 220 μs improvement in average inference time by the inference detection model configured with the filter count of {[64,128], any} can be associated with a reduced computational complexity.

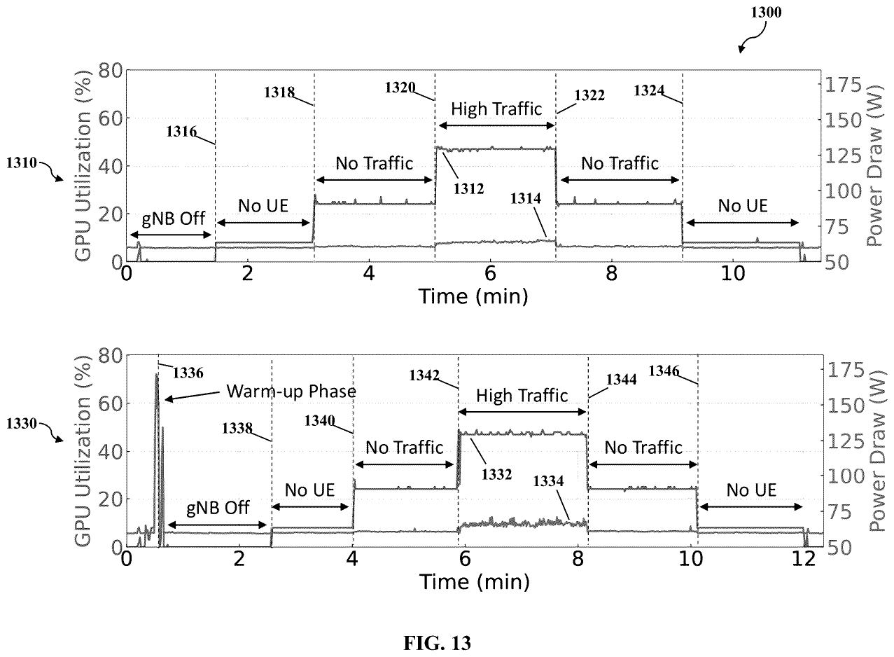

FIG. 13 is a diagram 1300 of example GPU utilization and power consumption metrics associated with in-band or inter-cell uplink interference detection, in accordance with aspects of the present disclosure. Diagram 1300 includes plot 1310 that illustrates example performance metrics over time corresponding to an example base station (“non-InterfO-RAN base station”) with a PHY layer that does not include an interference detection model. Diagram 1300 also includes plot 1330 that illustrates example performance metrics over time corresponding to another example base station (“InterfO-RAN base station”) with a PHY layer that does include an interference detection model. In an embodiment, the example InterfO-RAN base station can be implemented using protocol stack 202 of FIG. 2.

Plot 1310 includes lines 1312 and 1314, respectively, that illustrate PPU Utilization in percentages and power draw in watts over time by the example non-InterfO-RAN base station. Prior to time 1316, the example non-InterfO-RAN base station operates in a quiescent or a reduced power state (e.g., an “OFF” state). Around time 1316, the example non-InterfO-RAN base station transitions from the quiescent state to an active state (e.g., an “ON” state) such that the example non-InterfO-RAN base station becomes operational. No UEs have connected to or established links with the example non-InterfO-RAN base station prior to time 1318. A time interval between time 1316 and time 1318, corresponds to the “No UE” scenario described above with reference to FIG. 6 where no connections have been established between a base station and a UE. Around time 1318, a number of UEs connect to or establish links with the example non-InterfO-RAN base station. A time interval between time 1318 and time 1320, corresponds to the “No Traffic” scenario described above with reference to FIG. 6. Around time 1320, UL transmissions at the example non-InterfO-RAN base station increase to a level corresponding to the “High Traffic” scenario described above with reference to FIG. 6. Around time 1322, UL transmissions at the example non-InterfO-RAN base station decrease to a level corresponding to the “No Traffic” scenario described above with reference to FIG. 6. No UEs are connected to the example non-InterfO-RAN base station after time 1324.

Plot 1330 includes lines 1332 and 1334, respectively, that illustrate PPU utilization in percentages and power draw in watts over time by the example InterfO-RAN base station. Around time 1336, processing circuitry operating within the PHY layer of the InterfO-RAN base station initializes and allocates PPU resources to InterfO-RAN. Prior to time 1338, the example InterfO-RAN base station operates in a quiescent or a reduced power state (e.g., an “OFF” state). Time 1336 of plot 1330 corresponds to the warm-up phase described above with reference to FIG. 6. Around time 1338, the example InterfO-RAN base station transitions from the quiescent state to an active state (e.g., an “ON” state) such that the example InterfO-RAN base station becomes operational. No UEs have connected to or established links with the example InterfO-RAN base station prior to time 1338. A time interval between time 1336 and time 1338, corresponds to the “No UE” scenario described above with reference to FIG. 6 where no connections have been established between a base station and a UE. Around time 1338, a number of UEs connect to or establish links with the example InterfO-RAN base station. A time interval between time 1338 and time 1340, corresponds to the “No Traffic” scenario described above with reference to FIG. 6. Around time 1342, UL transmissions at the example InterfO-RAN base station increase to a level corresponding to the “High Traffic” scenario described above with reference to FIG. 6. Around time 1344, UL transmissions at the example InterfO-RAN base station decrease to a level corresponding to the “No Traffic” scenario described above with reference to FIG. 6. No UEs are connected to the example InterfO-RAN base station after time 1346.

A comparison between plot 1310 and plot 1330 illustrates that the interference detection model effectively balances workloads corresponding to inference operations without substantially straining RAN operations, while leveraging various optimizations such as TensorRT optimizations. For example, PPU utilization in plot 1330 at time 1346 relating to the warm-up phase operations described above with reference to FIG. 6 is about 21.2% compared to about 3.3 % PPU utilization in plot 1310. Another example, power draw in plot 1330 at time 1346 relating to the warm-up phase operations is about 82.73 W compared to about 61.79 W in plot 1310.

During “High Traffic” scenario conditions such as between time 1342 and time 1344 of plot 1330, power draw in the example InterfO-RAN base station is about 66.13 W with a standard deviation of about 1.77. Power draw in the example non-InterfO-RAN base station during “High Traffic” scenario conditions such as between time 1320 and time 1322 of plot 1310 is about 63.83 W with a standard deviation of 0.67. External to warm-up phase operations and “High Traffic” scenario conditions, PPU utilization and power draw at the example InterfO-RAN base station are substantially similar to PPU utilization and power draw at the example non-InterfO-RAN base station.

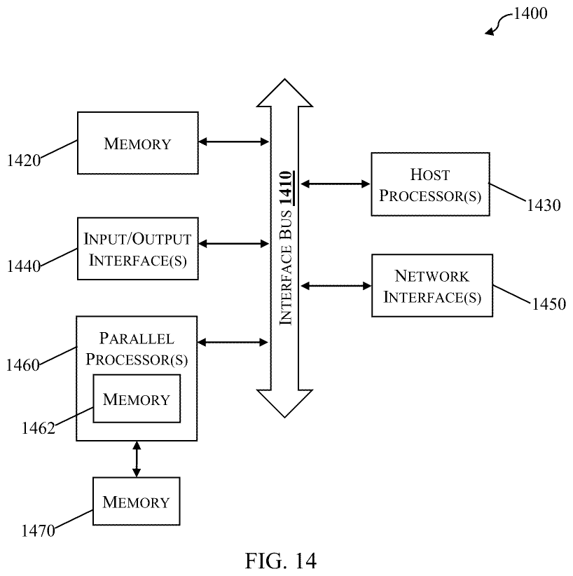

FIG. 14 is a block diagram that illustrates an example computer system, generally designated 1400, for implementing aspects of the present disclosure. As used herein, the phrase “computer system” generally refers to a dedicated computing device with processing power and storage memory, which supports operating software that underlies the execution of software, applications, and computer programs thereon. With reference to FIGS. 1-2 and 6, RAN 100, network node(s) 110, UE(s) 120, RAN 200, RU 210, DU 220, CU 230, UE 260, UE 280, RAN 600, RU(s) 622, UE(s) 624, RU(s) 632, UE(s) 634, RU(s) 652, RU(s) 662 can be implemented on one or more computer devices or systems, such as computer system 1400.

Computer system 1400 includes bus 1410 that directly or indirectly couples the following components: memory 1420, host processor(s) 1430, input/output (I/O) interface 1440, network interface 1450, and parallel processor(s) 1460. Bus 1410 is configured to communicate, transmit, and transfer data, controls, and commands between the various components of computer system 1400.

Memory 1420 may include a single memory device or a plurality of memory devices including, but not limited to, read-only memory (ROM), random access memory (RAM), volatile memory, non-volatile memory, static random-access memory (SRAM), dynamic random-access memory (DRAM), flash memory, cache memory, or any other device capable of storing information or data. Memory 1420 may also include data storage devices such as a hard drive, optical drive, tape drive, non-volatile solid-state device, or any other device capable of storing information or data.

Host processor(s) 1430 may include one or more devices selected from microprocessors, micro-controllers, digital signal processors, microcomputers, central processing units (CPUs), field programmable gate arrays, programmable logic devices, state machines, logic circuits, analog circuits, digital circuits, or any other devices that manipulate signals (analog or digital) based on operational instructions that are stored in memory 1420.

Parallel processor(s) 1460 may include one more devices selected from parallel processing units (“PPUs”), graphical processing units (“GPUs”), general purpose graphical processing units (“GPGPUs), and other processing devices configured to perform multiple tasks, threads, or computations in parallel, simultaneously, and/or substantially simultaneously. In an embodiment, parallel processor(s) 1460 can be configured to perform multiple tasks, threads, or computations in parallel, simultaneously, and/or substantially simultaneously without involvement of host processor(s) 1430. In an embodiment, parallel processor(s) 1460 can be configured to perform multiple tasks, threads, or computations in parallel, simultaneously, and/or substantially simultaneously without direct involvement of host processor(s) 1430. FIG. 14 illustrates host processor(s) 1430 and parallel processor(s) 1460 as physically separate devices. For example, host processor(s) 1430 can include a CPU and parallel processor(s) 1460 can include a GPU that is physically separate from the CPU.

FIG. 14 also illustrates that parallel processor(s) 1460 may operate on information or data stored in memory resources external to memory 1420, such memory resources may include memory resources internal to parallel processor(s) 1460 (e.g., memory 1462), memory resources external to parallel processor(s) 1460 (e.g., memory 1470). In some embodiments, parallel processor(s) 1460 can access and/or operate on information or data stored in memory resources external to memory 1420 without involvement of host processor(s) 1430. In some embodiments, parallel processor(s) 1460 can access and/or operate on information or data stored in memory resources external to memory 1420 without direct involvement of host processor(s) 1430.

For purposes of the present disclosure, host processor(s) 1430, parallel processor(s) 1460, and other related elements in FIG. 14 can generally referred to as “processing circuitry.” Examples of processing circuitry can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein.

I/O interface 1440 is configured to coordinate I/O traffic between memory 1420, processor 1430, network interface 1450, and any combination of input devices and output devices. Network interface 1450 enables computer system 1400 to exchange data with other computing devices via any suitable network. In a networked environment, program modules depicted relative to computer system 1400, or portions thereof, may be stored in a remote memory storage device accessible via network interface 1450. It will be appreciated that the network connections shown are exemplary and other means of establishing a communications link between the computers may be used.

In general, aspects of the present disclosure may be embodied in, and fully or partially automated by, code modules executed by one or more computers, computer processors, or processing circuits. The code modules executed to implement aspects of the present disclosure, whether implemented as part of an operating system or a specific application, component, program, object, module or sequence of instructions, or even a subset thereof, may be referred to herein as “program instructions,” “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the present disclosure. Computer-readable instructions for carrying out operations that implement aspects of the present disclosure may be, for example, assembly language or either source code or object code written in any combination of one or more programming languages.

Program code for implementing aspects of the present disclosure may be stored on or transmitted across some form of computer-readable media. The computer-readable media may include a variety of media that may be accessed by computer system 1400. By way of example, and not limitation, computer-readable media may include computer-readable storage media and computer-readable signal media. For purposes of the present disclosure, “computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

For purposes of the present disclosure, “computer-readable signal media” refers to a signal-bearing medium that is configured to transmit instructions to the hardware of computer system 1400, such as via a network. Signal media typically may embody computer-readable instructions, data structures, program modules, or other data in a modulated data signal, such as carrier waves, data signals, or other transport mechanisms. Signal media also include any information delivery media. For purposes of the present disclosure, “modulated data signal” refers to a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

The present disclosure describes particular embodiments and their detailed construction and operation. The embodiments described herein are set forth by way of illustration only and not limitation. Those skilled in the art will recognize, considering the teachings herein, that there may be a range of equivalents to the exemplary embodiments described herein. Most notably, other embodiments are possible, variations can be made to the embodiments described herein, and equivalents to the components, parts, or steps that make up the described embodiments may exist. For the sake of clarity and conciseness, certain aspects of components or steps of certain embodiments are presented without undue detail where such detail would be apparent to those skilled in the art considering the teachings herein and/or where such detail would obfuscate an understanding of more pertinent aspects of the embodiments.

Various aspects of the present disclosure may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

### REFERENCES

1. AI-RAN Alliance. 2024. AI-RAN Alliance: Vision and Mission White Paper. ai-ran. org/wp-content/uploads/2024/12/AI-RAN_Alliance_Whitepaper.pdf
2. Kamil Bechta, Cezary Ziółkowski, Jan M. Kelner, and Leszek Nowosielski. 2021. Modeling of Downlink Interference in Massive MIMO 5G Macro-Cell. Sensors 21, 2 (2021).
3. Archana Bura, Ushasi Ghosh, Dinesh Bharadia, and Srinivas Shakkottai. 2024. Windex: Realtime Neural Whittle Indexing for Scalable Service Guarantees in NextG Cellular Networks. arXiv:2406.01888 [eess.SY] (2024). arXiv:2406.01888 [eess.SY]
4. Shailesh Chaudhari and HyukJoon Kwon. 2022. Machine Learning based Inter¬ference Whitening in 5G NR MIMO Receiver. In IEEE 95th Vehicular Technology Conference. 1-6.
5. Chun-Yen Chen, Yin-Yi Chen, and Hung-Yu Wei. 2016. Multi-cell interference coordinated scheduling in mmWave 5G cellular systems. In Eighth International Conference on Ubiquitous and Future Networks (ICUFN). 912-917.
6. Erik Dahlman, Stefan Parkvall, and Johan Skold. 2018. 5G NR: The Next Generation Wireless Access Technology (1st ed.). Academic Press.
7. Salvatore D'Oro, Leonardo Bonati, Francesco Restuccia, and Tommaso Melodia. 2021. Coordinated 5G Network Slicing: How Constructive Interference Can Boost Network Throughput. IEEE/ACM Transactions on Networking 29, 4 (2021), 1881-1894.
8. Salvatore D'Oro, Michele Polese, Leonardo Bonati, Hai Cheng, and Tommaso Melodia. 2022. dApps: Distributed Applications for Real-Time Inference and Control in O-RAN. IEEE Communications Magazine 60, 11 (Nov. 2022), 52-58.
9. Ela Eren. 2025. Spectrum for private networks: Recent advancements by countries. tinyurl.com/as3cndjd
10. Xiaohu Ge, Song Tu, Guoqiang Mao, Cheng-Xiang Wang, and Tao Han. 2016. 5G Ultra-Dense Cellular Networks. IEEE Wireless Communications 23, 1 (2016), 72-79.
11. Ghaith Hattab, Eugene Visotsky, Mark C. Cudak, and Amitava Ghosh. 2019. Uplink Interference Mitigation Techniques for Coexistence of 5G Millimeter Wave Users With Incumbents at 70 and 80 GHz. IEEE Transactions on Wireless Communications 18, 1 (2019).
12. Mahmoud Kamel, Walaa Hamouda, and Amr Youssef. 2016. Ultra-Dense Net¬works: A Survey. IEEE Communications Surveys & Tutorials 18, 4 (2016), 2522-2545.
13. Woo-Hyun Ko, Ushasi Ghosh, Ujwal Dinesha, Raini Wu, Srinivas Shakkottai, and Dinesh Bharadia. 2023. EdgeRIC: Empowering Realtime Intelligent Op¬timization and Control in NextG Networks. arXiv:2304.11199 [cs.NI] (2023). arXiv:2304.11199 [cs.NI]
14. Mohammadreza Kouchaki, Aly Sabri Abdalla, and Vuk Marojevic. 2023. OpenAI dApp: An Open AI Platform for Distributed Federated Reinforcement Learning Apps in O-RAN. In IEEE Future Networks World Forum (FNWF). Baltimore, MD.
15. Merima Kulin, Tarik Kazaz, Ingrid Moerman, and Eli De Poorter. 2018. End-to-End Learning From Spectrum Data: A Deep Learning Approach for Wireless Signal Identification in Spectrum Monitoring Applications. IEEE Access 6 (2018), 18484-18501.
16. Lopamudra Kundu, Xingqin Lin, Elena Agostini, Vikrama Ditya, and Tim Martin. 2024. Hardware Acceleration for Open Radio Access Networks: A Contemporary Overview. IEEE Communications Magazine 62, 9 (2024), 160-167.
17. Andrea Lacava, Leonardo Bonati, Niloofar Mohamadi, Rajeev Gangula, Florian Kaltenberger, Pedram Johari, Salvatore D'Oro, Francesca Cuomo, Michele Polese, and Tommaso Melodia. 2025. dApps: Enabling Real-Time AI-Based Open RAN Control. arXiv:2501.16502 [cs.NI] (2025). arXiv:2501.16502 [cs.NI]
18. Lifeng Lai, Daquan Feng, and Fu-Chun Zheng. 2020. Interference Detection and Resource Allocation in LTE Unlicensed Systems. In 2020 IEEE Wireless Communi¬cations and Networking Conference (WCNC).
19. Leonardo Lo Schiavo, Gines Garcia-Aviles, Andres Garcia-Saavedra, Marco Gra-maglia, Marco Fiore, Albert Banchs, and Xavier Costa-Perez. 2024. CloudRIC: Open Radio Access Network (O-RAN) Virtualization with Shared Heterogeneous Computing. In Proceedings of the 30th Annual International Conference on Mobile Computing and Networking (Washington D.C., DC, USA). 558-572.
20. Amr Medhat, Mustafa Elattar, and Omar M Fahmy. 2021. LTE Uplink Interference Inspection Using Convolutional Neural Networks. In 2021 3rd Novel Intelligent and Leading Emerging Sciences Conference (NILES). 318-322.
21. Faris B. Mismar. 2022. Intermodulation Interference Detection in 6G Networks: A Machine Learning Approach. In IEEE Vehicular Technology Conference: (VTC-Spring).
22. Faris B. Mismar, Brian L. Evans, and Ahmed Alkhateeb. 2020. Deep Reinforcement Learning for 5G Networks: Joint Beamforming, Power Control, and Interference Coordination. IEEE Transactions on Communications 68, 3 (2020), 1581-1592.
23. Arvind Narayanan, Muhammad Iqbal Rochman, Ahmad Hassan, Bariq S. Fir-mansyah, Vanlin Sathya, Monisha Ghosh, Feng Qian, and Zhi-Li Zhang. 2022. A Comparative Measurement Study of Commercial 5G mmWave Deployments. In IEEE Conference on Computer Communications (INFOCOM).
24. NVIDIA. 2025. Aerial RAN co-lab over-the-air (Arc-Ota). docs.nvidia.com/aerial/aerial-ran-colab-ota/current/index.html
25. Michele Polese, Leonardo Bonati, Salvatore D'Oro, Stefano Basagni, and Tommaso Melodia. 2023. Understanding O-RAN: Architecture, Interfaces, Algorithms, Security, and Research Challenges. IEEE Communications Surveys & Tutorials 25, 2 (Second quarter 2023), 1376-1411. Jie Ren, Xin Zhang, and Yan Xin. 2019. Using Deep Convolutional Neural Network to Recognize LTE Uplink Interference. In 2019 IEEE Wireless Communications and Networking Conference (WCNC). 1-6.
26. Malte Schmidt, Dimitri Block, and Uwe Meier. 2017. Wireless interference iden¬tification with convolutional neural networks. In 2017 IEEE 15th International Conference on Industrial Informatics (INDIN). 180-185.
27. Maraj Uddin Ahmed Siddiqui, Faizan Qamar, Faisal Ahmed, Quang Ngoc Nguyen, and Rosilah Hassan. 2021. Interference Management in 5G and Beyond Network: Requirements, Challenges and Future Directions. IEEE Access 9 (2021).
28. Paolo Testolina, Michele Polese, Josep Jornet, Tommaso Melodia, and Michele Zorzi. 2024. Modeling Interference for the Coexistence of 6G and Passive Sensing Systems. IEEE Transactions on Wireless Communications (2024).
29. Daniel Uvaydov, Salvatore D'Oro, Francesco Restuccia, and Tommaso Melodia. 2021. DeepSense: Fast Wideband Spectrum Sensing Through Real-Time In-the-Loop Deep Learning. In IEEE Intl. Conf. on Computer Communications (INFOCOM). Vancouver, BC, Canada.
30. Davide Villa, Imran Khan, Florian Kaltenberger, Nicholas Hedberg, Ruben Soares da Silva, Anupa Kelkar, Chris Dick, Stefano Basagni, Josep M. Jornet, Tommaso Melodia, Michele Polese, and Dimitrios Koutsonikolas. 2024. An Open, Pro¬grammable, Multi-vendor 5G O-RAN Testbed with NVIDIA ARC and OpenAir-Interface. In Proceedings ofNext-generation Open and Programmable Radio Access Networks (NG-OPERA). Vancouver, BC, Canada.
31. Fan Wu, Rui Tan, Cong Zhang, Wenhao Fan, Xi Chen, Dusit Niyato, and Yuan'an Liu. 2021. Mixed Numerology Interference Recognition Approach for 5G NR. IEEE Wireless Communications Letters 10, 10 (2021), 2135-2139.
32. Wen-Bin Yang, Michael Souryal, and David Griffith. 2015. LTE uplink perfor¬mance with interference from in-band device-to-device (D2D) communications. In 2015 IEEE Wireless Communications and Networking Conference (WCNC). 669-674. doi.org/10.1109/WCNC.2015.7127550

What is claimed is:

1. A method for in-band uplink interference detection in a radio access network (RAN), the method comprising:
ingesting, at processing circuitry operating within a physical (PHY) layer of a protocol stack of the RAN, raw in-phase and quadrature (I/Q) data from an uplink transmission slot;
ingesting, at the processing circuitry, synchronous/contemporaneous observation data generated for the uplink transmission slot; and
generating, by an interference detection model executing on a parallel processing unit (PPU) of the processing circuitry, an in-band interference indication for the uplink transmission slot using the raw I/Q data and the synchronous observation data.

2. The method of claim 1, wherein processing of the PHY layer is accelerated using computational resources of the PPU.

3. The method of claim 1, further comprising:
initializing, by the processing circuitry, the interference detection model before a base station comprising the protocol stack becomes operational.

4. The method of claim 1, further comprising:
instantiating, by the processing circuitry, a thread for the interference detection model; and
assigning, by the processing circuitry, the thread to a dedicated core within a central processing unit (CPU) of the processing circuitry to isolate processing of the thread from processing of the PHY layer within different cores of the CPU.

5. The method of claim 1, wherein the interference detection model executes in-line with processing of PHY layer following execution of a physical uplink shared channel (PUSCH) pipeline of the PHY layer.

6. The method of claim 1, wherein ingesting the raw I/Q data comprises passing samples of I/Q data from the uplink transmission slot to the interference detection model upstream from equalization processing within the PHY layer.

7. The method of claim 1, wherein ingesting the synchronous observation data comprises normalizing and converting the synchronous observation data into fixed-size tensor formats for input to the interference detection model.

8. The method of claim 1, wherein ingesting the synchronous observation data comprises passing a PPU memory pointer to the interference detection model to directly transfer the synchronous observation data within memory of the PPU.

9. The method of claim 1, wherein the interference detection model is a baseline interference detection model constructed using source training data obtained from a source radio frequency (RF) environment, the method further comprising:
constructing a customized interference detection model for operating in a target RF environment using the baseline interference detection model and target training data specific to the target RF environment.

10. The method of claim 9, wherein the baseline interference detecting model comprises a neural network, and wherein constructing the customized interference detection model comprises maintaining batch normalization layers of the neural network while adjusting remaining layers of the neural network for operating in the target RF environment using the target training data.

11. The method of claim 1, further comprising:
asynchronously transferring, by a central processing unit (CPU) of the processing circuitry via an application programming interface, the raw I/Q data and the synchronous observation data from PPU memory to CPU memory at a frequency of once every N uplink transmission slots to generate a training dataset for offline training of interference detection models, wherein N is an integer greater than or equal to 1.

12. The method of claim 1, wherein a plurality of kernels executing in parallel with the interference detection model on the PPU provide the raw I/Q data and the synchronous observation data as input to the interference detection model, and the plurality of kernels are arranged in an acyclic graph structure where nodes of the acyclic graph structure correspond to individual kernels of the plurality of kernels and edges of the acyclic graph structure define inter-dependencies between the plurality of kernels.

13. The method of claim 1, wherein the interference detection model comprises a neural network with a concatenation layer that processes the synchronous observation data, and a flattening layer of the neural network couples the concatenation layer to a convolution layer of the neural network that extracts features of the raw I/Q data.

14. An apparatus for in-band uplink interference detection in a radio access network (RAN), comprising:
processing circuitry operating within a physical (PHY) layer of a protocol stack of the RAN; and
memory communicatively coupled to the processing circuitry, the memory storing program instructions executable by the processing circuitry to cause the apparatus to:
receive, by an interference detection model executing on a parallel processing unit (PPU) of the processing circuitry, pre-equalization in-phase and quadrature (I/Q) data from an uplink transmission slot;
receive, by the interference detection model, synchronous observation data generated for the uplink transmission slot; and
generate, by the interference detection model, an in-band interference indication for the uplink transmission slot using the pre-equalization I/Q data and the synchronous observation data.

15. The apparatus of claim 14, wherein the interference detection model generates the in-band interference indication at a latency of less than 10 milliseconds and within a single inference pass.

16. The apparatus of claim 14, wherein scheduler functions within a medium access control (MAC) layer of the protocol stack are accelerated using the PPU.

17. The apparatus of claim 14, wherein the apparatus is co-located with an Open RAN (O-RAN) distributed unit (DU) and a distributed application (dApp) deployed on the DU comprises the interference detection model.

18. The apparatus of claim 14, wherein the protocol stack of the RAN is distributed across multiple nodes of the RAN.

19. A non-transitory, computer readable medium comprising instructions, when executed by processing circuitry operating within a physical (PHY) layer of a protocol stack of a radio access network (RAN), cause the processing circuitry to:
causing an interference detection model executing on a parallel processing unit (PPU) of the processing circuitry to generate an in-band interference indication for an uplink transmission slot using raw baseband data from the uplink transmission slot and synchronous observation data generated for the uplink transmission slot; and
causing a network function of the RAN operating within a medium access control (MAC) layer of the protocol stack to allocate uplink resources of the RAN differently using the in-band interference indication.

20. The non-transitory, computer readable medium of claim 19, wherein the raw baseband data and the synchronous observation data are extracted from different stages of a physical uplink shared channel (PUSCH) pipeline of the PHY layer that operates in-line with the interference detection model.
